(19) United States
(12) Patent Application Publication
(10) Pub. No.: US 2003/0233871 A1
(43) Pub. Date: Dec. 25, 2003

(54) Multi-walled carbon nanotube scanning probe apparatus having a sharpened tip and method of sharpening for high resolution, high aspect ratio imaging

(75) Inventors: Cattien V. Nguyen, San Jose, CA (US); Ramsey M.D. Stevens, Palo Alto, CA (US)

Correspondence Address: LaRiviere, Grubman & Payne, LLP, P.O. Box 3140, Monterey, CA, 93942, US

(73) Assignee: Eloret Corporation, Sunnyvale, CA (US)

(21) Appl. No.: 10/440,050

(22) Filed: May 16, 2003

Related U.S. Application Data
(60) Provisional application No. 60/382,419, filed on May 17, 2002.

(51) Int. Cl. G01N 13/10

(52) U.S. Cl. 73/105; 29/595

(57) ABSTRACT

A method provides a sharpened Multi-Walled Carbon NanoTube Scanning Probe (MWCNT-SP) for a Atomic Force Microscopy (AFM). The MWCNT-SP is attached to a cantilever and help in the FMA. The tip of the MWCNT-SP is positioned in contact with a conducting substrate, and a voltage source is connected to the MWCNT-SP and to the substrate. The outer layers of the MWCNT-SP become hot, and the outermost carbon layers burns off, thereby creating a point on the MWCNT-SP.

### RELATED APPLICATIONS

This application claims priority to the U.S. Provisional Patent Application Serial No. 60/382,419, filed May 17, 2002, the entire content of which is incorporated herein.

### TECHNICAL FIELD

The present invention relates to the field of high resolution imaging, more particularly to improved Atomic Force Microscopy (AFM) scanning probes made from multi-walled carbon nanotubes with sharpened scanning tips, and a method of fabricating the improved scanning probes.

### BACKGROUND OF THE INVENTION

Atomic Force Microscopy (AFM) is used for producing images with resolution in the nanometer or smaller range. AFM instruments are well known, and are available from, for example, Veeco Instruments Inc, Corporate Headquarters, 100 Sunnyside Boulevard, Woodbury, N.Y. 11797. Unlike microscopes which are optical instruments, AFM instruments measure a surface topology by dragging a very small probe over the surface being measured. The probe resides on the end of a cantilever. As the probe moves over the surface, the probe follows the contours of the surface, resulting in vertical motion of the cantilever. Minute motion of the cantilever may be measured by methods such as using an interferomenter or a beam-bounce method. Methods such as a raster scan may be utilized to obtain a two-dimensional image of a surface.

Ultimately, AFM resolution is dependent on physical characteristics of the scanning probe including composition, size, shape, and rigidity of the probe. Both length and width (or diameter) of the probe affect resolution because, for example, the length limits the maximum depth of a detail that may be measured, and the width limits the minimum breadth of a detail that may be measured. Silicon probes are commonly used, but have tip diameter generally greater than 10 nm, and are easily damaged or worn during use. Scanning probes made of Carbon NanoTube (CNT) have been shown to be acceptable alternatives to silicon probes, and are known to be mechanically stable. Single-walled CNT Scanning Probes (SSP) can be produced with a tip diameter as small as 1 nm, but such a thin probe loses resolution due to effectively being widened due to thermal vibration. Consequently, SSP carbon nanotube scanning probe length is generally limited to less than 100 nm which limits the effective vertical distance of travel (aspect ratio) of the probe. Multi-Walled Carbon NanoTube Scanning Probes (MWCNT-SP) exhibit good mechanical strength and rigidity allowing lengths considerably greater than 100 nm, but they are relatively thick with a tip diameter of about 10 nm. As a result of the good mechanical strength and rigidity, MWCNT-SPs may be fabricated to be as long as one to two mm, while providing good lateral stability to mitigate thermal vibrations. However, MWCNT-SPs have lower resolution than SSP carbon nanotube scanning probes due to the thickness of the probe.

Attempts have been made to manufacture a MWCNT-SP with a small tip. For example, one known method is to oxidize the probe end to reduce diameter. In another method, the probe is plated, and then the plating is pealed away to reduce diameter. Unfortunately, these methods have not demonstrated a high yield, and are therefore costly. An additional method is to force the tube into a v shaped grove and apply a current as shown in U.S. Pat. No. 6,452,171 to Moloni.

An alternative sharpened carbon nanotube scanning probe, and method for sharpening, providing a small tip diameter with good lateral stability and high yield, is therefore needed.

### BRIEF SUMMARY OF THE INVENTION

This invention is a Multi-Walled Carbon NanoTube Scanning Probe (MWCNT-SP) apparatus having a sharpened tip and method of sharpening a MWCNT-SP. The invention provides improved lateral resolution without altering other desirable properties by locally stripping away the outer graphitic layers of the MWCNT-SP, producing a tip with a diameter approaching that of a single-walled carbon nanotube scanning probe. The method comprises mounting a conventionally formed MWCNT-SP into a holding fixture, positioning the MWCNT-SP in contact with a conducting substrate, and applying a DC bias between the MWCNT-SP and the conducting substrate for a period of time. The method produces a MWCNT-SP with the desirable characteristics of conventional MWCNT-SP, namely thermal stability, mechanical strength, and high aspect ratio, and with improved lateral resolution comparable to that of a single-walled carbon nanotube scanning probe.

### BRIEF DESCRIPTION OF THE DRAWINGS

The above and other aspects, features and advantages of the present invention will be more apparent from the following more particular description thereof, presented in conjunction with the following drawings wherein:

FIG. 1 shows a portion of an Atomic Force Microscope (AFM) including a cantilever and probe;

FIG. 2 shows a Multi-Walled Carbon NanoTube Scanning Probe (MWCNT-SP) of an AFM before sharpening;

FIG. 2A depicts a cross-sectional view of the MWCNT-SP taken along line 2A-2A of FIG. 2;

FIG. 3 depicts the use of an AFM to sharpen a MWCNT-SP according to the method of the present invention; and

FIG. 4 shows a sharpened MWCNT-SP according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing the general principles of the invention. The scope of the invention should be determined with reference to the claims.

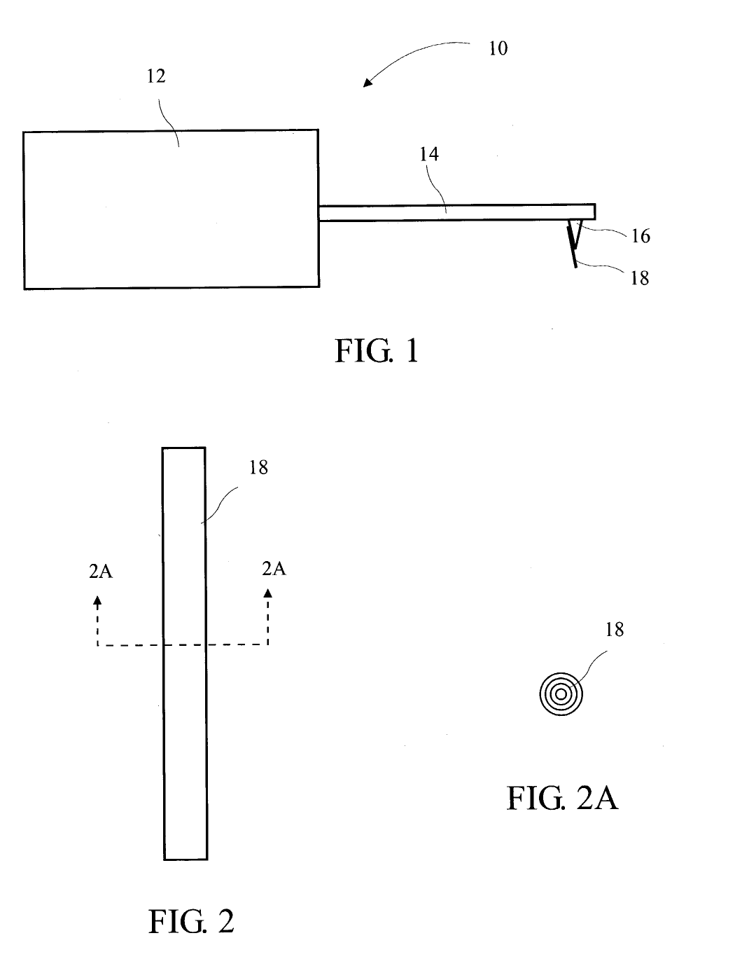

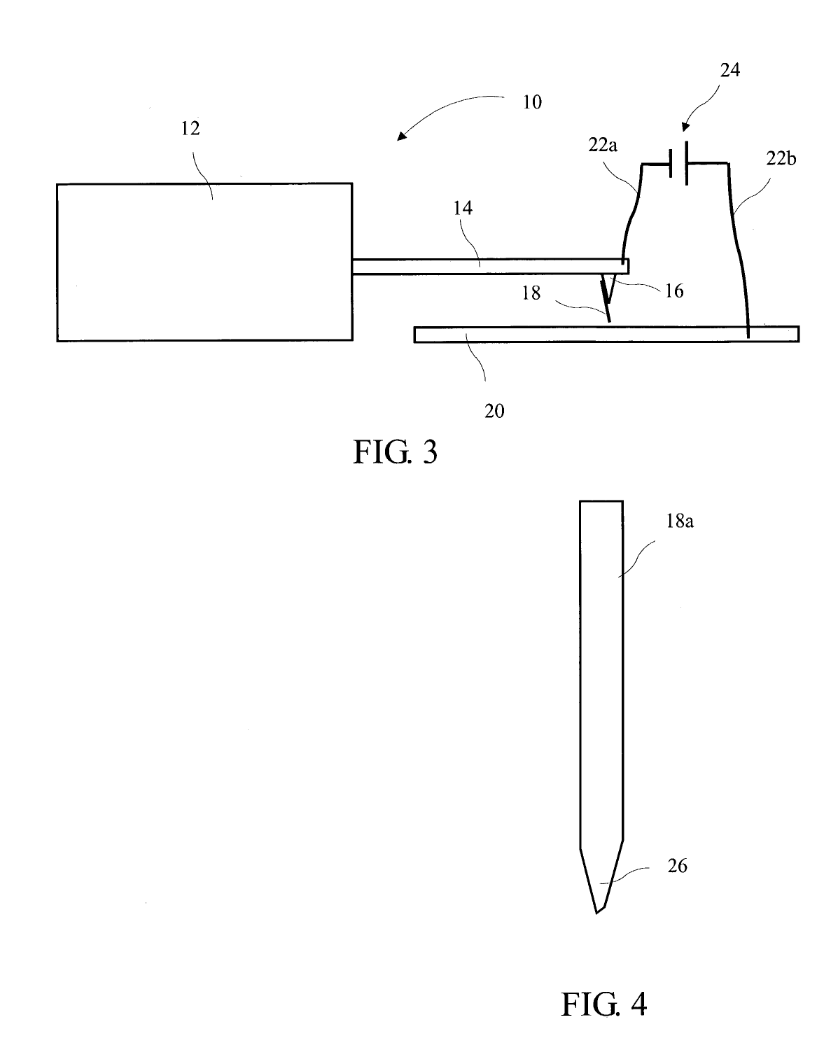

A portion of an Atomic Force Microscope (AFM) 10 including a holding fixture 12, a cantilever 14, a tip 16, and a Multi-Walled Carbon NanoTube Scanning Probe (MWCNT-SP) 18 is shown in FIG. 1. Such AFM 10 is used for producing images with resolution in the nanometer or smaller range. AFM instruments are well known, and are available from, for example, Veeco Instruments Inc, Corporate Headquarters, 100 Sunnyside Boulevard, Woodbury, N.Y. 11797.

A detailed view of the MWCNT-SP 18 (before sharpening) is shown in FIG. 2. The MWCNT-SP 18 exhibits good mechanical strength and rigidity allowing lengths considerably greater than 100 nm, but they are relatively thick with a tip diameter of about 10 nm. A cross-sectional view of the MWCNT-SP 18 is shown in FIG. 2A taken along line 2A-2A of FIG. 2. As shown in FIG. 2A. the MWCNT-SP 18 comprises concentric carbon rings.

The method of the present invention comprises mounting a conventionally formed and unsharpened MWCNT-SP 18 into the AFM 10, positioning the MWCNT-SP 18 in contact with a conducting substrate 20, applying a DC bias 24 through leads 22a and 22b, between the MWCNT-SP 18 and the conducting substrate 20 for a period of time. The DC bias is preferably typically less than 3V.

The method produces a sharpened MWCNT-SP 18a with a sharp tip 26, as shown in FIG. 4, with the desirable characteristics of conventional unsharpened MWCNT-SP 18, namely thermal stability, mechanical strength, and high aspect ratio, but with improved lateral resolution comparable to that of a single-walled carbon nanotube scanning probe.

While the invention herein disclosed has been described by means of specific embodiments and applications thereof, numerous modifications and variations could be made thereto by those skilled in the art without departing from the scope of the invention set forth in the claims.

What is claimed is:

1. A scanning probe apparatus, comprising:
a multi-walled carbon nanotube portion, said nanotube portion having a first diameter, and a scanning tip portion, said tip portion having a second diameter, wherein said second diameter is smaller than said first diameter.

2. The scanning probe apparatus of claim 1, wherein said scanning probe is at least 100 nm in length.

3. The scanning probe apparatus of claim 1, wherein said first diameter is equal or greater than 10 nm.

4. The scanning probe apparatus of claim 1, wherein said second diameter is equal to or less than 10 nm.

5. The scanning probe apparatus of claim 4, wherein said second diameter is equal to or less than 3 nm.

6. A method for fabricating a scanning probe apparatus for use in atomic force microscopy, comprising:
forming a multi-walled carbon nanotube scanning probe;
positioning said multi-walled carbon nanotube such that one end is in contact with a conducting substrate and the other end is attached to a source of electric current;
applying a current between said other end and said substrate; and
stripping away the outer layers of said multi-walled carbon nanotube to produce a reduced diameter area at the one end in contact with said conducting substrate.

7. A method for fabricating a scanning probe apparatus for use in atomic force microscopy as in claim 6, wherein said positioning step is accomplished by mounting said multi-walled carbon nanotube scanning probe into an atomic force microscope.

8. A method for fabricating a scanning probe apparatus for use in atomic force microscopy as in claim 7, wherein said current is a direct current bias of less than three volts.

9. A scanning probe apparatus, fabricated by the method comprising:
forming a multi-walled carbon nanotube scanning probe;
positioning said multi-walled carbon nanotube such that one end is in contact with a conducting substrate and the other end is attached to a source of electric current;
applying a current between said other end and said substrate; and
stripping away the outer layers of said multi-walled carbon nanotube to produce a reduced diameter area at the one end in contact with said conducting substrate.

10. A scanning probe apparatus as in claim 9, wherein said positioning step is accomplished by mounting said multi-walled carbon nanotube scanning probe into an atomic force microscope.

11. A scanning probe apparatus as in claim 9, wherein said current is a direct current bias of less than three volts.

12. A scanning probe apparatus as in claim 9, wherein the probe produced includes a multi-walled carbon nanotube portion, said nanotube portion having a first diameter, and a scanning tip portion, said tip portion having a second diameter, wherein said second diameter is smaller than said first diameter.

13. The scanning probe apparatus of claim 12, wherein said scanning probe is at least 100 nm in length.

14. The scanning probe apparatus of claim 12, wherein said first diameter is equal or greater than 10 nm.

15. The scanning probe apparatus of claim 12, wherein said second diameter is equal to or less than 10 nm.

16. The scanning probe apparatus of claim 15, wherein said second diameter is equal to or less than 3 nm.

17. The scanning probe apparatus of claim 15, wherein said scanning probe is at least 100 nm in length.

18. The scanning probe apparatus of claim 17, wherein said second diameter is equal to or less than 3 nm.
